(19) United States
(12) Patent Application Publication
(10) Pub. No.: US 2026/0097630 A1
(43) Pub. Date: Apr. 9, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Hochan An, Hwaseong-si (KR); Yeon Ho Kim, Hwaseong-si (KR); Hoyoung Jeong, Hwaseong-si (KR); Man Hee Park, Hwaseong-si (KR); Yeong Jun Kim, Hwaseong-si (KR); Jae Yeon Kim, Hwaseong-si (KR); Gwi Taek Kim, Hwaseong-si (KR)

(73) Assignees: HYUNDAI MOTOR COMPANY, Seoul (KR); KIA CORPORATION, Seoul (KR)

(21) Appl. No.: 19/222,309

(22) Filed: May 29, 2025

(30) Foreign Application Priority Data
Oct. 4, 2024 (KR) 10-2024-0134646

(51) Int. Cl. B60H 1/32

(52) U.S. Cl. CPC B60H 1/32284; B60H 2001/3297

(57) ABSTRACT

A heat pump system for a vehicle improves cooling and heating performance by applying a gas injection device that selectively operates in an air conditioning mode of vehicle interior to increase the flow rate of the refrigerant. The heat pump system is provided to minimize the cooling and heating load and simultaneously improve the overall performance and efficiency of the system by controlling the flow direction of the refrigerant introduced into the gas injection device according to the cooling and heating load.

### CROSS-REFERENCE TO RELATED APPLICATION

This application claims priority to and the benefit of Korean Patent Application No. 10-2024-0134646, filed with the Korean Intellectual Property Office on Oct. 4, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the cooling and heating performance.

### Description of the Related Art

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environmentally-friendly vehicle capable of substantially substituting for an internal combustion engine vehicle is required, and the environmentally-friendly vehicle is classified into an electric vehicle driven using a fuel cell or electricity as a power source and a hybrid vehicle driven using an engine and a battery.

In the electric vehicle or the hybrid vehicle among these environmentally-friendly vehicles, a separate heater is not used unlike an air conditioner of a general vehicle, and an air conditioner used in the environmentally-friendly vehicle is generally called a heat pump system.

The electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in the hybrid vehicle or the electric vehicle according to the related art, cooling means, a heat pump system, and a battery cooling system, respectively, should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort.

In addition, for heating the vehicle interior, the heating performance may be deteriorated due to the lack of heat source, the electricity consumption may be increased due to the usage of the electric heater, and the power consumption of the compressor may be increased.

The above information disclosed in this Background section is only for enhancement of understanding of the background of the disclosure, and therefore it may contain information that does not form the prior art that is already known to a person having ordinary skill in the art.

### SUMMARY

The present disclosure provides a heat pump system for a vehicle capable of improving cooling and heating performance by applying a gas injection device selectively operating in an air conditioning mode of vehicle interior to increase the flow rate of the refrigerant.

In addition, the present disclosure provides a heat pump system for a vehicle capable of minimizing the cooling and heating load and simultaneously improving the overall performance and efficiency of the system by controlling the flow direction of the refrigerant introduced into the gas injection device according to the cooling and heating load.

A heat pump system for a vehicle includes: a compressor configured to compress a refrigerant; a condenser connected to the compressor through a refrigerant line and configured to condense the refrigerant; and a first expansion valve connected to the condenser through the refrigerant line. The heat pump system further includes an evaporator connected to the first expansion valve through the refrigerant line, connected to the compressor through the refrigerant line, and configured to evaporate the supplied refrigerant. The heat pump system further includes a connection line having a first end connected to the refrigerant line between the condenser and the first expansion valve, and a second end connected to the refrigerant line between the compressor and the evaporator. The heat pump system further includes a chiller provided on the connection line, and configured to heat-exchange the refrigerant introduced through the connection line with a coolant to adjust a temperature of the coolant. The heat pump system further includes a second expansion valve provided on the connection line at an upstream end of the chiller. The heat pump system further includes a gas injection device provided on the refrigerant line between the condenser and the first expansion valve, and configured to selectively expand the refrigerant supplied from the condenser and flow the expanded refrigerant and selectively supply a partial refrigerant among the supplied refrigerant to the compressor to increase a flow rate of the refrigerant circulating through the refrigerant line, where a flow direction of the refrigerant is controlled through an operation control of the gas injection device depending on at least one mode for a temperature control of a vehicle interior.

The condenser may include a first condenser connected to the compressor through the refrigerant line, and configured to condense the refrigerant by heat-exchanging the refrigerant supplied from the compressor with the coolant. The cooler may further include a receiver dryer connected to the first condenser through the refrigerant line. The cooler may further include a second condenser connected to the receiver dryer through the refrigerant line, and configured to additionally condense the refrigerant by heat-exchanging the refrigerant supplied from the receiver dryer with the coolant.

The gas injection device may include a heat-exchanger provided on the refrigerant line between the condenser and the first expansion valve. The gas injection device may further include a first line having a first end connected to the refrigerant line between the condenser and the heat-exchanger, and a second end connected to the heat-exchanger. The gas injection device may further include a third expansion valve provided on the first line at an upstream end of the heat-exchanger. The gas injection device may further include a second line having a first end connected to the third expansion valve, and a second end connected to the refrigerant line between the heat-exchanger and the first expansion valve. The gas injection device may further include a third line having a first end connected to the heat-exchanger and a second end connected to the compressor.

The heat-exchanger may operate when the expanded refrigerant is supplied and may be configured to supply the gaseous refrigerant among the supplied refrigerant to the compressor through the third line to increase the flow rate of the refrigerant circulating through the refrigerant line.

When operation of the gas injection device is required, the third expansion valve may expand the refrigerant supplied from the condenser through the first line or the refrigerant supplied from the heat-exchanger through the second line, and may supply the expanded refrigerant to the heat-exchanger.

The at least one mode may include a first cooling mode for cooling a battery module while cooling the vehicle interior, by operating the gas injection device with the refrigerant discharged from the heat-exchanger. The at least one mode may further include a second cooling mode for cooling the battery module while cooling the vehicle interior, by operating the gas injection device with the refrigerant discharged from the condenser. The at least one mode may further include a first heating mode for heating the vehicle interior, by operating the gas injection device with the refrigerant discharged from the heat-exchanger. The at least one mode may further include a second heating mode for heating the vehicle interior, by operating the gas injection device with the refrigerant discharged from the condenser.

In the first cooling mode, the refrigerant line interconnecting the compressor, the condenser, the first expansion valve, and the evaporator may be opened. The connection line may be opened by the second expansion valve. A portion of the first line connecting a first end of the first line to the third expansion valve may be closed by the third expansion valve. A remaining first line connecting the third expansion valve to the heat-exchanger may be opened by the third expansion valve. The second line may be opened by the third expansion valve. The third line may be opened. The first expansion valve may expand the refrigerant introduced through the refrigerant line and may supply the expanded refrigerant to the evaporator. The second expansion valve may expand the refrigerant introduced through the connection line and may supply the expanded refrigerant to the chiller. The third expansion valve may expand the refrigerant introduced through the second line, and may supply the expanded refrigerant to the heat-exchanger through the opened portion of the first line. The heat-exchanger may supply a gaseous refrigerant among an interiorly introduced refrigerant to the compressor through the opened third line.

In the second cooling mode, the refrigerant line interconnecting the compressor, the condenser, the first expansion valve, and the evaporator may be opened. The connection line may be opened by the second expansion valve. The first line may be opened by the third expansion valve. The second line may be closed by the third expansion valve. The third line may be opened. The first expansion valve may expand the refrigerant introduced through the refrigerant line and may supply the expanded refrigerant to the evaporator. The second expansion valve may expand the refrigerant introduced through the connection line and may supply the expanded refrigerant to the chiller. The third expansion valve may expand the refrigerant introduced through the first line, and may supply the expanded refrigerant to the heat-exchanger through the first line. The heat-exchanger may supply a gaseous refrigerant among an interiorly introduced refrigerant to the compressor through the opened third line.

In the first heating mode, a portion of the refrigerant line connecting the compressor and the condenser may be opened. A portion of the refrigerant line connecting the condenser to the first end of the connection line and a portion of the refrigerant line connecting the second end of the connection line to the compressor may be opened. A portion of the refrigerant line connecting the evaporator to the first end of the connection line, and a portion of the refrigerant line connecting the second end of the connection line to the evaporator may be closed by the first expansion valve. The connection line may be opened by the second expansion valve. A portion of the first line connecting the first end of the first line to the third expansion valve may be closed by the third expansion valve. A remaining first line connecting the third expansion valve to the heat-exchanger may be opened by the third expansion valve. The second line may be opened by the third expansion valve. The third line may be opened. An operation of the first expansion valve is stopped. The second expansion valve may expand the refrigerant introduced through the connection line and may supply the expanded refrigerant to the chiller. The third expansion valve may expand the refrigerant introduced through the second line, and may supply the expanded refrigerant to the heat-exchanger through the opened portion of the first line. The heat-exchanger may supply the gaseous refrigerant among an interiorly introduced refrigerant to the compressor through the opened third line.

In the second heating mode, a portion of the refrigerant line connecting the compressor and the condenser may be opened. A portion of the refrigerant line connecting the condenser to a first end of the connection line and a portion of the refrigerant line connecting the second end of the connection line to the compressor may be opened. A portion of the refrigerant line connecting the evaporator to the first end of the connection line, and a portion of the refrigerant line connecting the second end of the connection line to the evaporator may be closed by the first expansion valve. The connection line may be opened by the second expansion valve. The first line may be opened by the third expansion valve. The second line may be closed by the third expansion valve. The third line may be opened. An operation of the first expansion valve is stopped. The second expansion valve may expand the refrigerant introduced through the connection line and may supply the expanded refrigerant to the chiller. The third expansion valve may expand the refrigerant introduced through the first line, and may supply the expanded refrigerant to the heat-exchanger through the first line. The heat-exchanger may supply the gaseous refrigerant among an interiorly introduced refrigerant to the compressor through the opened third line.

A heat pump system may further include an accumulator provided on the refrigerant line between the evaporator and the compressor, a bypass line having a first end connected to the refrigerant line between the compressor and the condenser, and a second end connected to the accumulator, and a fourth expansion valve provided on the bypass line.

The fourth expansion valve may open the bypass line during hot gas heating for heating the vehicle interior by using the refrigerant without recollecting heat, and may expand the refrigerant introduced into the bypass line from the compressor and supply the expanded refrigerant to the accumulator.

The at least one mode may further include a first hot gas heating mode for heating the vehicle interior by using the refrigerant without recollecting heat, by operating the gas injection device, and a second hot gas heating mode for heating the vehicle interior by using the refrigerant without recollecting heat, without operating the gas injection device.

In the first hot gas heating mode, a portion of the refrigerant line connecting the compressor and the condenser may be opened. A portion of the refrigerant line connecting the condenser to the first end of the connection line and a portion of the refrigerant line connecting the second end of the connection line to the compressor may be opened. A portion of the refrigerant line connecting the evaporator to the first end of the connection line, and a portion of the refrigerant line connecting the second end of the connection line to the evaporator may be closed by the first expansion valve. The connection line may be opened by the second expansion valve. The first line may be opened by the third expansion valve. The second line may be closed by the third expansion valve. The third line may be opened. The bypass line may be opened by the fourth expansion valve. An operation of the first expansion valve is stopped. The second expansion valve may expand the refrigerant introduced through the connection line and may supply the expanded refrigerant to the chiller. The third expansion valve may expand the refrigerant introduced through the first line, and may supply the expanded refrigerant to the heat-exchanger through the first line. The fourth expansion valve may expand the refrigerant introduced through the bypass line, and may supply the expanded refrigerant to the accumulator through the bypass line. The heat-exchanger may supply the gaseous refrigerant among an interiorly introduced refrigerant to the compressor through the opened third line.

In the second hot gas heating mode, a portion of the refrigerant line connecting the compressor and the condenser may be opened. A portion of the refrigerant line connecting the condenser to the first end of the connection line and a portion of the refrigerant line connecting the second end of the connection line to the compressor may be opened. A portion of the refrigerant line connecting the evaporator to the first end of the connection line, and a portion of the refrigerant line connecting the second end of the connection line to the evaporator may be closed by the first expansion valve. The connection line may be opened by the second expansion valve. The first line may be closed by the third expansion valve. The second line may be closed by the third expansion valve. The third line is closed, the bypass line may be opened by the fourth expansion valve. An operation of the first expansion valve and the third expansion valve is stopped. The second expansion valve may expand the refrigerant introduced through the connection line and may supply the expanded refrigerant to the chiller. The fourth expansion valve may expand the refrigerant introduced through the bypass line, and may supply the expanded refrigerant to the accumulator through the bypass line.

The first and second expansion valves may be 2-way electronic expansion valves configured to selectively expand the refrigerant while controlling the flow direction of the supplied refrigerant. The third expansion valve may be a 3-way electronic expansion valve configured to selectively expand the refrigerant while controlling the flow direction of the refrigerant.

A control apparatus may be provided on the refrigerant line between the evaporator and the compressor, to adjust a pressure of the refrigerant line, or to prevent the refrigerant from flowing backward in the refrigerant line.

A heat pump system may further include a battery module through which the coolant circulates, and a heating device through which the coolant circulates to heat the vehicle interior by using a high-temperature coolant, where the condenser is connected to the heating device through a first coolant line through which the coolant circulates, and where the chiller is connected to the battery module through a second coolant line through which the coolant circulates.

The first coolant line may be opened to connect the condenser and the heating device when heating the vehicle interior.

When the battery module is to be cooled while cooling the vehicle interior, or when a waste heat of the battery module is to be recollected while heating the vehicle interior, the second coolant line may be opened to connect the chiller and the battery module.

As described above, according to a heat pump system for a vehicle according to an embodiment of the present disclosure, cooling and heating performance may be improved by applying a gas injection device selectively operating in an air conditioning mode of vehicle interior to increase the flow rate of the refrigerant.

In addition, the present disclosure may minimize the cooling and heating load and simultaneously improve the overall performance and efficiency of the system by controlling the flow direction of the refrigerant introduced into the gas injection device according to the cooling and heating load.

In addition, according to the present disclosure, the performance of the system by using the gas injection device may be maximized while minimizing the required components, and accordingly, streamlining and simplification of the system may be achieved.

In addition, according to the present disclosure, through streamlining of an entire system, it is possible to reduce manufacturing cost and weight and improve space utilization.

### BRIEF DESCRIPTION OF THE DRAWINGS

FIG. 1 is a block diagram illustrating a heat pump system for a vehicle according to an embodiment of the present disclosure.

FIG. 2 is an operation diagram according to a first cooling mode of a heat pump system for a vehicle according to an embodiment of the present disclosure.

FIG. 3 is an operation diagram according to a second cooling mode of a heat pump system for a vehicle according to an embodiment of the present disclosure.

FIG. 4 is an operation diagram according to a first heating mode of a heat pump system for a vehicle according to an embodiment of the present disclosure.

FIG. 5 is an operation diagram according to a second heating mode of a heat pump system for a vehicle according to an embodiment of the present disclosure.

FIG. 6 is an operation diagram according to a first hot gas heating mode of a heat pump system for a vehicle according to an embodiment of the present disclosure.

FIG. 7 is an operation diagram according to a second hot gas heating mode of a heat pump system for a vehicle according to an embodiment of the present disclosure.

### DETAILED DESCRIPTION

Some embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include” and variations thereof such as “comprises” or “comprising”, should understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

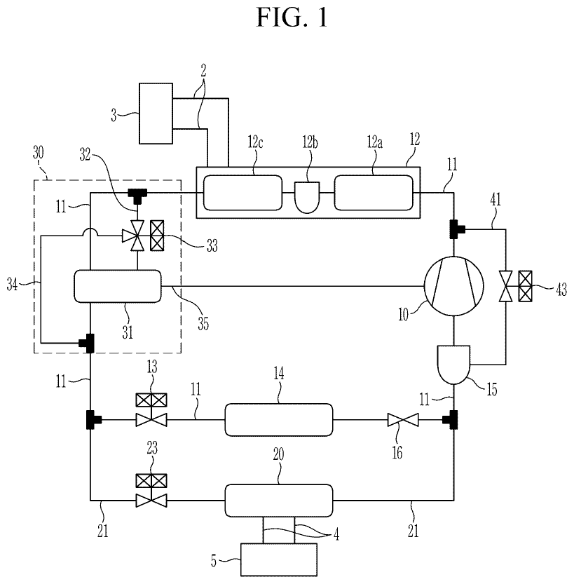

FIG. 1 is a block diagram illustrating a heat pump system for a vehicle according to an embodiment of the present disclosure.

A heat pump system for a vehicle according to an embodiment of the present disclosure may improve the cooling and heating performance by applying a gas injection device 30 that selectively operates in a selected air conditioning mode of the vehicle interior among a cooling mode, a heating mode, or a heating-dehumidifying mode and thereby increasing a flow rate of a refrigerant.

In addition, a heat pump system according to an embodiment of the present disclosure may minimize the cooling and heating load and simultaneously improve the overall performance and efficiency of the system, by controlling a flow direction of the refrigerant introduced into the gas injection device 30 according to the cooling and heating load.

Referring to FIG. 1, in order to heat the vehicle interior by using a high-temperature coolant, the heat pump system may include a heating device 3 through which the coolant circulates, and a battery module 5 through which the coolant circulates.

Such a heat pump system may further include a compressor 10, a condenser 12, a first expansion valve 13, an evaporator 14, a chiller 20, a connection line 21, a second expansion valve 23, and the gas injection device 30.

The heating device 3 may be connected to the condenser 12 through a first coolant line 2 through which the coolant circulates.

When heating the vehicle interior, the first coolant line 2 may be opened to connect the heating device 3 and the condenser 12, in order to supply a high-temperature coolant to the heating device 3.

Accordingly, the coolant having its temperature increased through heat-exchange with the refrigerant at the condenser 12 may be supplied to the heating device 3 along the first coolant line 2.

The high-temperature coolant supplied to the heating device 3 may increase a temperature of an ambient air passing through the heating device 3. In other words, the introduced ambient air may be converted to a high-temperature state while passing through the heating device 3 and then introduced into the vehicle interior, thereby implementing heating of the vehicle interior.

In an embodiment of the present disclosure, the battery module 5 may be connected to the chiller 20 through a second coolant line 4 through which the coolant circulates.

When the battery module 5 is to be cooled while cooling the vehicle interior, or when the waste heat of the battery module 5 is to be recollected while heating the vehicle interior, the second coolant line 4 may be opened to connect the chiller 20 and the battery module 5.

A water pump (not shown) may be provided on each of the first coolant line 2 and the second coolant line 4, and the coolant may be selectively circulated by an operation of respective water pumps.

In an embodiment of the present disclosure, the compressor 10 may compress the supplied refrigerant and flow the compressed refrigerant to a refrigerant line 11 so that the refrigerant may circulate along the refrigerant line 11.

The condenser 12 may be connected to the compressor 10 through the refrigerant line 11. The condenser 12 may condense the supplied refrigerant through heat-exchange with the coolant.

In other words, when heating the vehicle interior, the condenser 12 may condense the refrigerant supplied from the compressor 10 through heat-exchange with the coolant supplied from the heating device 3 through the first coolant line 2.

The condenser 12 may include a first condenser 12a, a receiver dryer 12b, and a second condenser 12c.

The first condenser 12a may be connected to the compressor 10 through the refrigerant line 11.

The first condenser 12a may condense the refrigerant supplied from the compressor 10 through heat-exchange with the coolant supplied from the heating device 3.

The receiver dryer 12b may be connected to the first condenser 12a through the refrigerant line 11. The receiver dryer 12b may separate the gaseous refrigerant remaining in the liquid refrigerant condensed by the first condenser 12a.

In other words, the receiver dryer 12b may separate a gas component from the introduced refrigerant, and may only discharge the liquid refrigerant by filtering moisture and foreign substances.

The second condenser 12c may be connected to the receiver dryer 12b through the refrigerant line 11.

The second condenser 12c may additionally condense the refrigerant supplied from the receiver dryer 12b through heat-exchange with the coolant supplied from the heating device 3.

In an embodiment of the present disclosure, the first expansion valve 13 may be connected to the condenser 12 through the refrigerant line 11. The first expansion valve 13 may selectively expand the introduced refrigerant.

The first expansion valve 13 may be a 2-way electronic expansion valve configured to selectively expand the refrigerant while controlling the flow direction of the supplied refrigerant.

The evaporator 14 may be connected to the first expansion valve 13 through the refrigerant line 11. In addition, the evaporator 14 may be connected to the compressor 10 through the refrigerant line 11. The evaporator 14 may evaporate the refrigerant supplied from the first expansion valve 13 through heat-exchange with the ambient air.

The evaporator 14 may be provided inside a HVAC module (not shown), together with the heating device 3.

Accordingly, the ambient air passing through the evaporator 14 may be cooled by the low-temperature refrigerant supplied to the evaporator 14 while passing through the evaporator 14. The cooled ambient air may be introduced into the vehicle interior, thereby cooling the vehicle interior.

The heat pump system may further include an accumulator 15 and a control apparatus 16.

The accumulator 15 may be provided on the refrigerant line 11 between the evaporator 14 and the compressor 10. The accumulator 15 may only supply the gaseous refrigerant to the compressor 10, and thereby improve the efficiency and durability of the compressor 10.

The control apparatus 16 may be provided on the refrigerant line 11 between the evaporator 14 and the accumulator 15. The control apparatus 16 may be configured to adjust the pressure of the refrigerant line 11, or to prevent the refrigerant from flowing backward in the refrigerant line 11 toward the evaporator 14.

The control apparatus 16 configured as such may be a regulator or a check valve.

In an embodiment of the present disclosure, the chiller 20 may adjust a temperature of the coolant selectively supplied through the second coolant line 4 by heat-exchanging the refrigerant supplied from the condenser 12 with the coolant.

In other words, the chiller 20 may be a water-cooled heat-exchanger configured to heat-exchange an interiorly introduced refrigerant with the coolant.

The chiller 20 may be connected to the refrigerant line 11 through the connection line 21.

A first end of the connection line 21 may be connected to the refrigerant line 11 between the condenser 12 and the first expansion valve 13.

A second end of the connection line 21 may be connected to the refrigerant line 11 between the evaporator 14 and the compressor 10. The second end of the connection line 21 may be connected to the refrigerant line 11 between the control apparatus 16 and the accumulator 15.

The chiller 20 may adjust the temperature of the coolant by heat-exchanging the coolant selectively introduced through the second coolant line 4 with the refrigerant selectively supplied from the condenser 12.

Accordingly, the coolant heat-exchanged with the refrigerant at the chiller 20 may be selectively supplied to the battery module 5, to adjust a temperature of the battery module 5.

The chiller 20 configured as such may be disposed in parallel with the evaporator 14 through the connection line 21.

In an embodiment of the present disclosure, the second expansion valve 23 may be provided on the connection line 21 in an upstream end of the chiller 20.

When the battery module 5 is to be cooled by using the coolant heat-exchanged with the refrigerant while cooling the vehicle interior, the second expansion valve 23 may expand the refrigerant introduced through the connection line 21 and flow the expanded refrigerant to the chiller 20.

In other words, when the battery module 5 is to be cooled while cooling the vehicle interior, the second expansion valve 23 may expand the refrigerant introduced through the connection line 21 to lower its temperature, and flow the expanded refrigerant to the chiller 20, to further lower temperature of the coolant passing through an interior of the chiller 20.

Accordingly, the coolant cooled while passing through the chiller 20 may be introduced into the battery module 5, thereby achieving more efficient cooling.

When the waste heat generated from the battery module 5 is to be recollected while heating the vehicle interior, the second expansion valve 23 may expand the refrigerant introduced through the connection line 21, and may supply the expanded refrigerant to the chiller 20.

Accordingly, the chiller 20 may evaporate the refrigerant through heat-exchange with the coolant supplied through the second coolant line 4.

The chiller 20 may recollect the waste heat of the battery module 5 while heat-exchanging the refrigerant supplied from the second expansion valve 23 with the coolant supplied from the battery module 5.

The second expansion valve 23 configured as such may be a 2-way electronic expansion valve configured to selectively expand the refrigerant while controlling the flow direction of the supplied refrigerant.

The upstream end of the chiller 20 may be set based on the flow direction of the refrigerant. Based on the direction in which the refrigerant flows along the connection line 21, a location where the refrigerant is introduced into the chiller 20 may be defined as an upstream end of the chiller 20, and a location where the refrigerant is discharged from the chiller 20 may be defined as a downstream end of the chiller 20.

In an embodiment of the present disclosure, the chiller 20 is connected to the battery module 5 through the second coolant line 4, but is not limited thereto, and an electrical component (not shown) may be connected to the chiller 20 through a separate coolant line (not shown).

The gas injection device 30 may be connected to the refrigerant line 11 between the condenser 12 and the first expansion valve 13.

The gas injection device 30 may selectively expand the refrigerant supplied from the condenser 12 and flow the expanded refrigerant, and may selectively supply a partial refrigerant among the supplied refrigerant to the compressor 10 to increase the flow rate of the refrigerant circulating through the refrigerant line 11.

When cooling or heating the vehicle interior, the gas injection device 30 configured as such may be selectively operated.

Referring to FIG. 1, the gas injection device 30 may include a heat-exchanger 31, a first line 32, a third expansion valve 33, a second line 34, and a third line 35.

The heat-exchanger 31 may be provided on the refrigerant line 11 between the condenser 12 and the first expansion valve 13. The heat-exchanger 31 may operate when the expanded refrigerant is supplied.

A first end of the first line 32 may be connected to the refrigerant line 11 between the condenser 12 and the heat-exchanger 31. A second end of the first line 32 may be connected to the heat-exchanger 31.

In an embodiment of the present disclosure, the third expansion valve 33 may be provided on the first line 32 at an upstream end of the heat-exchanger 31. The third expansion valve 33 may selectively expand the introduced refrigerant.

A first end of the second line 34 may be connected to the third expansion valve 33. A second end of the second line 34 may be connected to the refrigerant line 11 between the heat-exchanger 31 and the first expansion valve 13.

When operation of the gas injection device 30 is required, the third expansion valve 33 may expand the refrigerant supplied from the condenser 12 through the first line 32 or the refrigerant supplied from the heat-exchanger 31 through the second line 34, and may supply the expanded refrigerant to the heat-exchanger 31.

The third expansion valve 33 configured as such may be a 3-way electronic expansion valve configured to selectively expand the refrigerant while controlling the flow direction of the refrigerant.

A first end of the third line 35 may be connected to the heat-exchanger 31. A second end of the third line 35 may be connected to the compressor 10.

When the expanded refrigerant is supplied to the heat-exchanger 31, the third line 35 may selectively supply the gaseous refrigerant from the heat-exchanger 31 to the compressor 10.

In other words, the third line 35 may connect the heat-exchanger 31 and the compressor 10 so that the gaseous refrigerant separated at the heat-exchanger 31 may be selectively introduced into the compressor 10.

In the gas injection device 30 configured as such, the heat-exchanger 31 may heat-exchange the refrigerant discharged from the condenser 12 and the refrigerant expanded at the third expansion valve 33 with each other.

The gaseous refrigerant among the refrigerant heat-exchanged while passing through the heat-exchanger 31 may be supplied to the compressor 10 through the third line 35. The liquid refrigerant among the refrigerant heat-exchanged while passing through the heat-exchanger 31 may flow to the refrigerant line 11.

In other words, when the expanded refrigerant is supplied to the heat-exchanger 31, the heat-exchanger 31 may supply the gaseous refrigerant among the supplied refrigerant to the compressor 10 through the third line 35, to increase the flow rate of the refrigerant circulating through the refrigerant line 11.

The heat pump system configured as such may further include a bypass line 41 and a fourth expansion valve 43.

A first end of the bypass line 41 may be connected to the refrigerant line 11 between the compressor 10 and the condenser 12. A second end of the bypass line 41 may be connected to the accumulator 15.

The fourth expansion valve 43 may be provided on the bypass line 41.

The fourth expansion valve 43 may selectively open or close the bypass line 41. The fourth expansion valve 43 may selectively expand the refrigerant introduced through the bypass line 41.

In other words, the fourth expansion valve 43 may be a 2-way electronic expansion valve configured to selectively expand the refrigerant while controlling the flow direction of the refrigerant.

The fourth expansion valve 43 may open the bypass line 41 during hot gas heating, which heats the vehicle interior by using the refrigerant without recollecting heat, and may expand the refrigerant introduced into the bypass line 41 from the compressor 10 and supply the expanded refrigerant to the accumulator 15.

When heating of the vehicle interior is required under low external temperature conditions and the heat generated by the electrical component and the battery module 5 is insufficient during the early stage of vehicle operation, the heat pump system may perform heating of the vehicle interior by directly using the high pressure and high-temperature refrigerant.

As described above, heating the vehicle interior by using only the refrigerant may be referred to as the hot gas heating.

In the heat pump system configured as such, the flow direction of the refrigerant may be controlled through an operation control of the gas injection device 30 depending on at least one mode for a temperature control of the vehicle interior.

The at least one mode may include a first cooling mode, a second cooling mode, a first heating mode, a second heating mode, a first hot gas heating mode, and a second hot gas heating mode.

In the first cooling mode, the gas injection device 30 may be operated with the refrigerant discharged from the heat-exchanger 31, and the battery module 5 may be cooled while cooling the vehicle interior.

In the second cooling mode, the gas injection device 30 may be operated with the refrigerant discharged from the condenser 12, and the battery module 5 may be cooled while cooling the vehicle interior.

In the first heating mode, the gas injection device 30 may be operated with the refrigerant discharged from the heat-exchanger 31, and the vehicle interior may be heated.

In the second heating mode, the gas injection device 30 may be operated with the refrigerant discharged from the condenser 12, and the vehicle interior may be heated.

In the first hot gas heating mode, the gas injection device 30 may be operated, and the vehicle interior may be heated by using the refrigerant without recollecting heating.

In the second hot gas heating mode, the gas injection device 30 may not be operated, and the vehicle interior may be heated by using the refrigerant without recollecting heating.

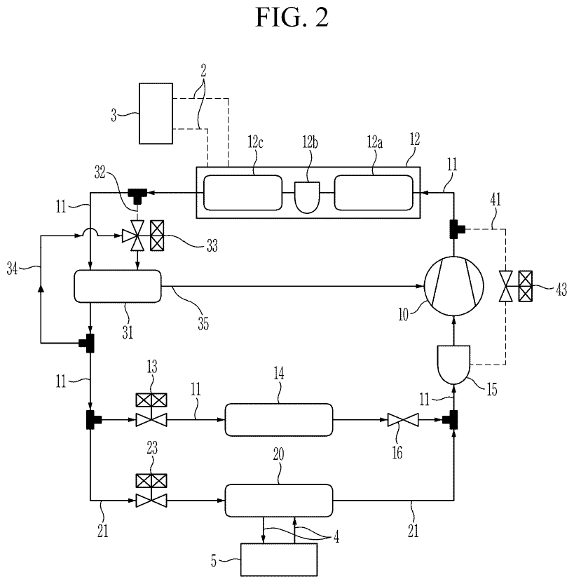

Hereinafter, an operation and action of a heat pump system for a vehicle according to an embodiment of the present disclosure configured as described above are described in detail with reference to FIG. 2-7.

An operation in the first cooling mode for cooling the battery module 5 while cooling the vehicle interior, in which the gas injection device 30 is operated with the refrigerant discharged from the heat-exchanger 31, is described in detail with reference to FIG. 2.

FIG. 2 is an operation diagram according to the first cooling mode of a heat pump system for a vehicle according to an embodiment of the present disclosure.

Referring to FIG. 2, in the first cooling mode, the refrigerant line 11 interconnecting the compressor 10, the condenser 12, the first expansion valve 13, the evaporator 14 may be opened.

The connection line 21 may be opened by the second expansion valve 23,

In an embodiment of the present disclosure, a portion of the first line 32 connecting the first end of the first line 32 to the third expansion valve 33 may be closed by the third expansion valve 33.

A remaining first line 32 connecting the third expansion valve 33 to the heat-exchanger 31 may be opened by the third expansion valve 33.

The second line 34 may be opened by the third expansion valve 33. The third line 35 may be opened.

In such a state, the refrigerant compressed at the compressor 10 may be introduced into the condenser 12 along the refrigerant line 11. The first coolant line 2 may be closed so that the coolant is not supplied to the heating device 3.

The condenser 12 may condense the refrigerant by using the coolant supplied from a radiator (not shown) and an electrical component.

The first condenser 12a may condense the refrigerant by using the coolant supplied from the radiator. The refrigerant having passed through the first condenser 12a may be introduced into the receiver dryer 12b along the refrigerant line 11.

The receiver dryer 12b may separate a gas component from the introduced refrigerant, and may only discharge the liquid refrigerant by filtering moisture and foreign substances. The refrigerant discharged from the receiver dryer 12b may be supplied to the second condenser 12c along the refrigerant line 11.

The second condenser 12c may additionally condense the refrigerant supplied from the receiver dryer 12b by heat-exchanging with the coolant.

The refrigerant additionally condensed at the second condenser 12c may be introduced into the heat-exchanger 31 along the refrigerant line 11. A partial refrigerant among the refrigerant having passed through the heat-exchanger 31 may be introduced into the third expansion valve 33 along the second line 34.

The third expansion valve 33 may expand the refrigerant introduced through the second line 34, and may supply the expanded refrigerant to the heat-exchanger 31 through the opened portion of the first line 32.

Accordingly, the heat-exchanger 31 may heat-exchange the refrigerant introduced through the first line 32 and the refrigerant supplied from the condenser 12 with each other. Thereafter, the heat-exchanger 31 may supply the gaseous refrigerant among the heat-exchanged refrigerant to the compressor 10 through the third line 35.

Through such an operation, the gas injection device 30 may flow the gaseous refrigerant discharged from the heat-exchanger 31 back to the compressor 10 through the third line 35, to increase the flow rate of the refrigerant circulating through the refrigerant line 11.

The refrigerant introduced into the heat-exchanger 31 from the condenser 12 may be additionally condensed through heat-exchange with the refrigerant supplied through the first line 32.

A remaining refrigerant among the refrigerant discharged from the heat-exchanger 31 may be introduced into the first expansion valve 13 and the second expansion valve 23 along the refrigerant line 11 and the connection line 21, respectively.

The first expansion valve 13 may expand the refrigerant introduced through the refrigerant line 11 and supply the expanded refrigerant to the evaporator 14. In addition, the control apparatus 16 may open the refrigerant line 11 connecting the evaporator 14 and the accumulator 15.

In such a state, the ambient air introduced into the HVAC module (not shown) may be cooled while passing through the evaporator 14 by the low-temperature refrigerant introduced into the evaporator 14. The cooled ambient air may cool the vehicle interior by being directly introduced into the vehicle interior.

The second expansion valve 23 may expand the refrigerant introduced through the connection line 21 and supply the expanded refrigerant to the chiller 20.

The refrigerant introduced into the chiller 20 may cool the coolant while heat-exchanging with the coolant supplied from the battery module 5 through the second coolant line 4.

The coolant cooled at the chiller 20 may be supplied to the battery module 5 along the second coolant line 4. Accordingly, the battery module 5 may be efficiently cooled by the coolant cooled at the chiller 20.

In other words, the coolant circulated through the second coolant line 4 may efficiently cool the battery module 5 while repeatedly performing the above-described operation.

The refrigerant having passed through the evaporator 14 and the chiller 20, respectively, may be introduced into the accumulator 15 along the refrigerant line 11. Thereafter, the refrigerant may pass through the accumulator 15 and be introduced into the compressor 10.

In other words, the refrigerant having passed through the accumulator 15, and the refrigerant supplied from the heat-exchanger 31 through the third line 35 may be introduced into the compressor 10. The introduced refrigerant may be compressed by the compressor 10.

The refrigerant compressed at the compressor 10 may pass through the condenser 12, and then may be supplied to the heat-exchanger 31 along the refrigerant line 11.

The heat pump system may repeatedly perform the above-described processes.

The heat pump system may increase the flow rate of the refrigerant flowing along the refrigerant line 11 while repeatedly performing the above-described operation.

The heat-exchanger 31 may heat-exchange the refrigerant expanded at the third expansion valve 33 after flowing along the second line 34 in a state additionally condensed by the heat-exchanger 31 and the refrigerant introduced from the condenser 12 with each other, thereby further increasing the condensation amount of the refrigerant.

As such, the gas injection device 30 may flow the refrigerant having its condensation amount increased through the flow control of the refrigerant, so that the subcooling of the refrigerant discharged from the condenser 12 may be increased.

When the subcooling of the refrigerant discharged from the condenser 12 is increased, the enthalpy difference may become large in the evaporator 14, thereby minimizing the cooling load.

The heat pump system may cool the vehicle interior more efficiently when the cooling load is large, by controlling the flow direction of the refrigerant discharged from the condenser 12 through the operation control of the gas injection device 30.

The heat pump system may increase the flow rate of the refrigerant flowing along the refrigerant line 11, to improve the overall cooling performance and efficiency.

Simultaneously, the heat pump system may efficiently cool the battery module 5 by using the low-temperature coolant cooled at the chiller 20.

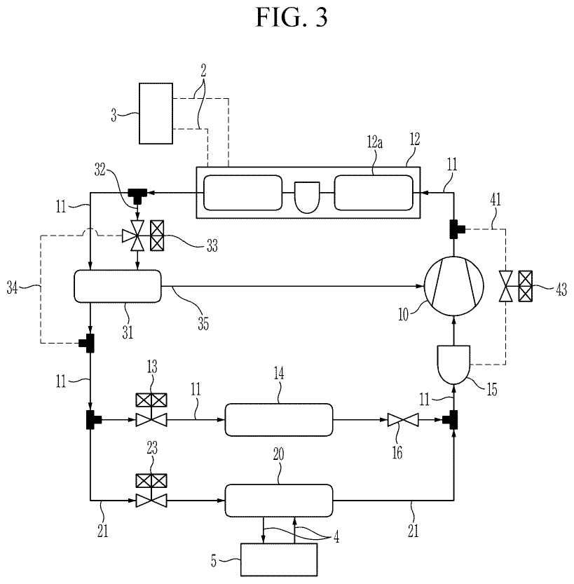

In an embodiment of the present disclosure, an operation in the second cooling mode for cooling the battery module 5 while cooling the vehicle interior, in which the gas injection device 30 is operated with the refrigerant discharged from the condenser 12, is described in detail with reference to FIG. 3.

FIG. 3 is an operation diagram according to the second cooling mode of a heat pump system for a vehicle according to an embodiment of the present disclosure.

Referring to FIG. 3, in the second cooling mode, the refrigerant line 11 interconnecting compressor 10, the condenser 12, the first expansion valve 13, the evaporator 14 may be opened.

The connection line 21 may be opened by the second expansion valve 23,

In an embodiment of the present disclosure, the first line 32 may be opened by the third expansion valve 33. The second line 34 may be closed by the third expansion valve 33. In addition, the third line 35 may be opened.

In such a state, the refrigerant compressed at the compressor 10 may be introduced into the condenser 12 along the refrigerant line 11. The first coolant line 2 may be closed so that the coolant is not supplied to the heating device 3.

The condenser 12 may condense the refrigerant by using the coolant supplied from a radiator (not shown) and an electrical component.

In more detail, the first condenser 12a may condense the refrigerant by using the coolant supplied from the radiator. The refrigerant having passed through the first condenser 12a may be introduced into the receiver dryer 12b along the refrigerant line 11.

The receiver dryer 12b may separate a gas component from the introduced refrigerant, and may only discharge the liquid refrigerant by filtering moisture and foreign substances. The refrigerant discharged from the receiver dryer 12b may be supplied to the second condenser 12c along the refrigerant line 11.

The second condenser 12c may additionally condense the refrigerant supplied from the receiver dryer 12b by heat-exchanging with the coolant.

A partial refrigerant among the refrigerant additionally condensed by the second condenser 12c may be introduced into the first line 32.

The third expansion valve 33 may expand the refrigerant introduced through the first line 32, and may supply the expanded refrigerant to the heat-exchanger 31 through the first line 32.

A remaining refrigerant among the refrigerant additionally condensed by the second condenser 12c may be introduced into the heat-exchanger 31 along the refrigerant line 11.

Accordingly, the heat-exchanger 31 may heat-exchange the refrigerant introduced through the first line 32 and the refrigerant supplied from the condenser 12 with each other. The heat-exchanger 31 may supply the gaseous refrigerant among the heat-exchanged refrigerant to the compressor 10 through the third line 35.

Through such an operation, the gas injection device 30 may flow the gaseous refrigerant discharged from the heat-exchanger 31 back to the compressor 10 through the third line 35, to increase the flow rate of the refrigerant circulating through the refrigerant line 11.

The refrigerant introduced into the heat-exchanger 31 from the condenser 12 may be additionally condensed through heat-exchange with the refrigerant supplied through the first line 32.

The refrigerant additionally condensed at the heat-exchanger 31 may be introduced into the first expansion valve 13 and the second expansion valve 23 along the refrigerant line 11 and the connection line 21, respectively.

The first expansion valve 13 may expand the refrigerant introduced through the refrigerant line 11 and supply the expanded refrigerant to the evaporator 14. The control apparatus 16 may open the refrigerant line 11 connecting the evaporator 14 and the accumulator 15.

In such a state, the ambient air introduced into the HVAC module (not shown) may be cooled while passing through the evaporator 14 by the low-temperature refrigerant introduced into the evaporator 14. The cooled ambient air may cool the vehicle interior by being directly introduced into the vehicle interior.

The second expansion valve 23 may expand the refrigerant introduced through the connection line 21 and supply the expanded refrigerant to the chiller 20.

The refrigerant introduced into the chiller 20 may cool the coolant while heat-exchanging with the coolant supplied from the battery module 5 through the second coolant line 4.

The coolant cooled at the chiller 20 may be supplied to the battery module 5 along the second coolant line 4. Accordingly, the battery module 5 may be efficiently cooled by the coolant cooled at the chiller 20.

In other words, the coolant circulated through the second coolant line 4 may efficiently cool the battery module 5 while repeatedly performing the above-described operation.

The refrigerant having passed through the evaporator 14 and the chiller 20, respectively, may be introduced into the accumulator 15 along the refrigerant line 11. Thereafter, the refrigerant may pass through the accumulator 15 and be introduced into the compressor 10.

In other words, the refrigerant having passed through the accumulator 15, and the refrigerant supplied from the heat-exchanger 31 through the third line 35 may be introduced into the compressor 10. The introduced refrigerant may be compressed by the compressor 10.

The refrigerant compressed at the compressor 10 may pass through the condenser 12, and then may be supplied to the heat-exchanger 31 along the refrigerant line 11.

The heat pump system may repeatedly perform the above-described processes.

In other words, the heat pump system may increase the flow rate of the refrigerant flowing along the refrigerant line 11 while repeatedly performing the above-described operation.

The heat-exchanger 31 may heat-exchange the refrigerant expanded at the third expansion valve 33 after flowing from the condenser 12 to the first line 32 and the refrigerant condensed at the condenser 12 with each other, so that the condensation amount of the refrigerant may be decreased compared to the first cooling mode described above.

As such, the gas injection device 30 may flow the refrigerant having its condensation amount decreased through the flow control of the refrigerant, so that the subcooling of the refrigerant discharged from the condenser 12 may be decreased compared to the first cooling mode described above.

In other words, the second cooling mode may be operated when the cooling load is small, and by controlling the flow direction of the refrigerant discharged from the condenser 12 through the operation control of the gas injection device 30, the vehicle interior can be cooled more efficiently when the cooling load is small compared to the first cooling mode.

The heat pump system may increase the flow rate of the refrigerant flowing along the refrigerant line 11, to improve the overall cooling performance and efficiency.

The heat pump system may efficiently cool the battery module 5 by using the low-temperature coolant cooled at the chiller 20.

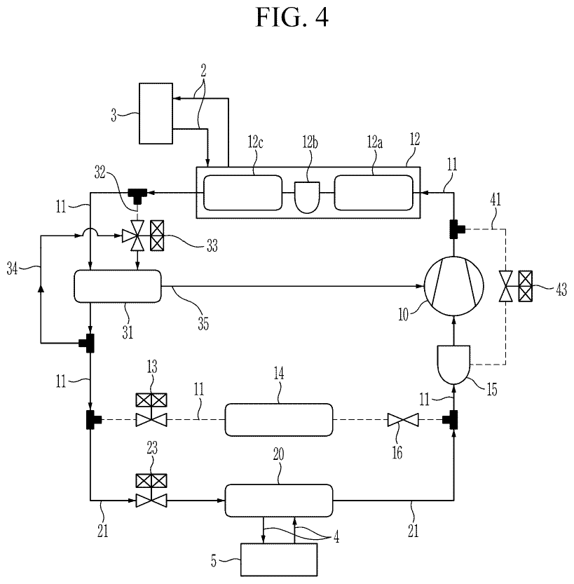

In an embodiment of the present disclosure, an operation in the first heating mode for heating the vehicle interior, in which the gas injection device 30 is operated with the refrigerant discharged from the heat-exchanger 31, is described in detail with reference to FIG. 4.

FIG. 4 is an operation diagram according to the first heating mode of a heat pump system for a vehicle according to an embodiment of the present disclosure.

Referring to FIG. 4, in the first heating mode, a portion of the refrigerant line 11 connecting the compressor 10 and the condenser 12 may be opened.

A portion of the refrigerant line 11 connecting the condenser 12 to the first end of the connection line 21 and a portion of the refrigerant line 11 connected the second end of the connection line 21 to the compressor 10 may be opened.

A portion of the refrigerant line 11 connecting the evaporator 14 to the first end of the connection line 21, and a portion of the refrigerant line 11 connecting the second end of the connection line 21 to the evaporator 14 may be closed by the first expansion valve 13.

The connection line 21 may be opened by the second expansion valve 23.

An operation of the first expansion valve 13 may be stopped. Accordingly, the refrigerant is not supplied to the evaporator 14.

The control apparatus 16 may close the refrigerant line 11 connecting the evaporator 14 and the second end of the connection line 21, to prevent the refrigerant flowing along the connection line 21 from flowing backward to the evaporator 14.

In an embodiment of the present disclosure, a portion of the first line 32 connecting the first end of the first line 32 to the third expansion valve 33 may be closed by the third expansion valve 33.

A remaining first line 32 connecting the third expansion valve 33 to the heat-exchanger 31 may be opened by the third expansion valve 33.

The second line 34 may be opened by the third expansion valve 33. The third line 35 may be opened.

In such a state, the refrigerant compressed at the compressor 10 may be introduced into the condenser 12 along the refrigerant line 11. The first coolant line 2 may be opened so that the coolant is supplied to the heating device 3.

Accordingly, the refrigerant introduced into the condenser 12 may be condensed while being heat-exchanged with the coolant supplied from the heating device 3 through the first coolant line 2. The coolant having its temperature increased through heat-exchange with the refrigerant at the condenser 12 may be supplied to the heating device 3.

The first condenser 12a may condense the refrigerant by using the coolant supplied from the heating device 3. The refrigerant having passed through the first condenser 12a may be introduced into the receiver dryer 12b along the refrigerant line 11.

The receiver dryer 12b may separate a gas component from the introduced refrigerant, and may only discharge the liquid refrigerant by filtering moisture and foreign substances. The refrigerant discharged from the receiver dryer 12b may be supplied to the second condenser 12c along the refrigerant line 11.

The second condenser 12c may additionally condense the refrigerant supplied from the receiver dryer 12b by heat-exchanging with the coolant supplied from the heating device 3.

The refrigerant additionally condensed at the second condenser 12c may be introduced into the heat-exchanger 31 along the refrigerant line 11. The partial refrigerant among the refrigerant having passed through the heat-exchanger 31 may be introduced into the third expansion valve 33 along the second line 34.

The third expansion valve 33 may expand the refrigerant introduced through the second line 34, and may supply the expanded refrigerant to the heat-exchanger 31 through the opened portion of the first line 32.

Accordingly, the heat-exchanger 31 may heat-exchange the refrigerant introduced through the first line 32 and the refrigerant supplied from the condenser 12 with each other. Thereafter, the heat-exchanger 31 may supply the gaseous refrigerant among the heat-exchanged refrigerant to the compressor 10 through the third line 35.

Through such an operation, the gas injection device 30 may flow the gaseous refrigerant discharged from the heat-exchanger 31 back to the compressor 10 through the third line 35, to increase the flow rate of the refrigerant circulating through the refrigerant line 11.

The refrigerant introduced into the heat-exchanger 31 from the condenser 12 may be additionally condensed through heat-exchange with the refrigerant supplied through the first line 32.

A remaining refrigerant among the refrigerant discharged from the heat-exchanger 31 may be introduced into the second expansion valve 23 along a portion of the refrigerant line 11 and the connection line 21.

The second expansion valve 23 may expand the refrigerant introduced through the connection line 21 and supply the expanded refrigerant to the chiller 20.

The refrigerant introduced into the chiller 20 may cool the coolant while heat-exchanging with the coolant supplied from the battery module 5 through the second coolant line 4.

The coolant may have its temperature increased by recollecting the waste heat from the battery module 5 while cooling the battery module 5. The coolant having its temperature increased through such an operation may be supplied to the chiller 20.

The chiller 20 may recollect the waste heat of the battery module 5 through heat-exchanging the coolant supplied from the battery module 5 through the second coolant line 4 with the refrigerant.

The refrigerant having passed through the chiller 20 may be introduced into the accumulator 15 along the connection line 21 and the opened refrigerant line 11. Thereafter, the refrigerant may pass through the accumulator 15 and be introduced into the compressor 10.

In other words, the refrigerant having passed through the accumulator 15, and the refrigerant supplied from the heat-exchanger 31 through the third line 35 may be introduced into the compressor 10. The introduced refrigerant may be compressed by the compressor 10.

The refrigerant compressed at the compressor 10 may pass through the condenser 12, and then may be supplied to the heat-exchanger 31 along the refrigerant line 11.

The heat pump system may repeatedly perform the above-described processes.

The ambient air introduced into the vehicle interior may be converted into a high-temperature state through heat-exchange with the high-temperature coolant introduced into the heating device 3 and introduced into the vehicle interior, thereby implementing heating of the vehicle interior.

Accordingly, the refrigerant circulated in the heat pump system may smoothly recollect the waste heat at the chiller 20 from the coolant having its temperature increased while passing through the battery module 5, thereby improving the overall heating performance and efficiency.

The present disclosure may improve the heating efficiency and performance while minimizing usage of a separate electric heater.

In other words, the heat pump system may increase the flow rate of the refrigerant flowing along the refrigerant line 11 while repeatedly performing the above-described operation.

The heat-exchanger 31 may additionally condense the refrigerant condensed at the condenser 12 through heat-exchange with the refrigerant expanded at the third expansion valve 33 after flowing from the heat-exchanger 31 to the second line 34, and by flowing the additionally condensed refrigerant, the subcooling of the refrigerant discharged from the condenser 12 may be increased.

While the waste heat generated from the battery module 5 or an electrical component (not shown) is sufficient, when the subcooling of the refrigerant discharged from the condenser 12 is increased, the enthalpy difference may become large in the chiller 20, so that the waste heat may be more smoothly recollected and used for heating of the vehicle interior.

As such, the heat pump system may sufficiently recollect and use the waste heat by controlling the flow direction of the refrigerant discharged from the condenser 12 through the operation control of the gas injection device 30, thereby improving the heating performance and efficiency.

The gas injection device 30 may increase the flow rate of the refrigerant circulating through the refrigerant line 11, thereby maximizing the heating performance.

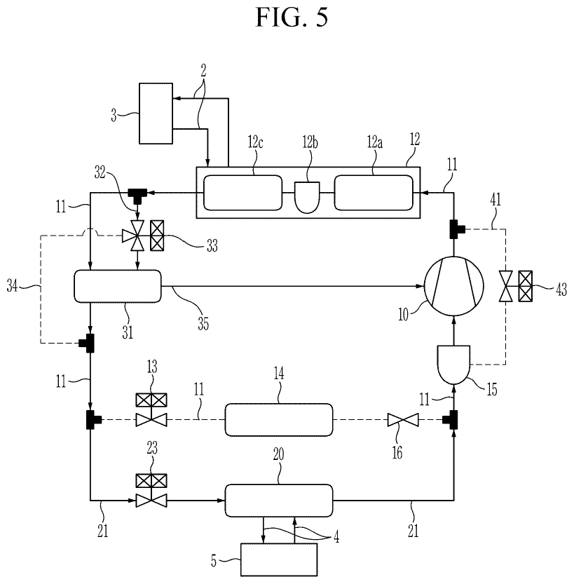

In an embodiment of the present disclosure, an operation in the second heating mode for heating the vehicle interior, in which the gas injection device 30 is operated with the refrigerant discharged from the condenser 12, is described in detail with reference to FIG. 5.

FIG. 5 is an operation diagram according to the second heating mode of a heat pump system for a vehicle according to an embodiment of the present disclosure.

Referring to FIG. 5, in the second heating mode, a portion of the refrigerant line 11 connecting the compressor 10 and the condenser 12 may be opened.

A portion of the refrigerant line 11 connecting the condenser 12 to the first end of the connection line 21 and a portion of the refrigerant line 11 connected the second end of the connection line 21 to the compressor 10 may be opened.

A portion of the refrigerant line 11 connecting the evaporator 14 to the first end of the connection line 21, and a portion of the refrigerant line 11 connecting the second end of the connection line 21 to an evaporator 17 may be closed by the first expansion valve 13.

The connection line 21 may be opened by the second expansion valve 23.

The operation of the first expansion valve 13 may be stopped. Accordingly, the refrigerant is not supplied to the evaporator 14.

The control apparatus 16 may close the refrigerant line 11 connecting the evaporator 14 and the second end of the connection line 21, to prevent the refrigerant flowing along the connection line 21 from flowing backward to the evaporator 14.

In an embodiment of the present disclosure, the first line 32 may be opened by the third expansion valve 33. The second line 34 may be closed by the third expansion valve 33. In addition, the third line 35 may be opened.

In such a state, the refrigerant compressed at the compressor 10 may be introduced into the condenser 12 along the refrigerant line 11. The first coolant line 2 may be opened so that the coolant is supplied to the heating device 3.

Accordingly, the refrigerant introduced into the condenser 12 may be condensed while being heat-exchanged with the coolant supplied from the heating device 3 through the first coolant line 2. The coolant having its temperature increased through heat-exchange with the refrigerant at the condenser 12 may be supplied to the heating device 3.

The first condenser 12a may condense the refrigerant by using the coolant supplied from the heating device 3. The refrigerant having passed through the first condenser 12a may be introduced into the receiver dryer 12b along the refrigerant line 11.

The receiver dryer 12b may separate a gas component from the introduced refrigerant, and may only discharge the liquid refrigerant by filtering moisture and foreign substances. The refrigerant discharged from the receiver dryer 12b may be supplied to the second condenser 12c along the refrigerant line 11.

The second condenser 12c may additionally condense the refrigerant supplied from the receiver dryer 12b by heat-exchanging with the coolant supplied from the heating device 3.

A partial refrigerant among the refrigerant additionally condensed by the second condenser 12c may be introduced into the first line 32.

The third expansion valve 33 may expand the refrigerant introduced through the first line 32, and may supply the expanded refrigerant to the heat-exchanger 31 through the first line 32.

A remaining refrigerant among the refrigerant additionally condensed by the second condenser 12c may be introduced into the heat-exchanger 31 along the refrigerant line 11.

Accordingly, the heat-exchanger 31 may heat-exchange the refrigerant introduced through the first line 32 and the refrigerant supplied from the condenser 12 with each other. Thereafter, the heat-exchanger 31 may supply the gaseous refrigerant among the heat-exchanged refrigerant to the compressor 10 through the third line 35.

Through such an operation, the gas injection device 30 may flow the gaseous refrigerant discharged from the heat-exchanger 31 back to the compressor 10 through the third line 35, to increase the flow rate of the refrigerant circulating through the refrigerant line 11.

The refrigerant introduced into the heat-exchanger 31 from the condenser 12 may be additionally condensed through heat-exchange with the refrigerant supplied through the first line 32.

A remaining refrigerant among the refrigerant discharged from the heat-exchanger 31 may be introduced into the second expansion valve 23 along a portion of the refrigerant line 11 and the connection line 21.

The second expansion valve 23 may expand the refrigerant introduced through the connection line 21 and supply the expanded refrigerant to the chiller 20.

The refrigerant introduced into the chiller 20 may cool the coolant while heat-exchanging with the coolant supplied from the battery module 5 through the second coolant line 4.

The coolant may have its temperature increased by recollecting the waste heat from the battery module 5 while cooling the battery module 5. The coolant having its temperature increased through such an operation may be supplied to the chiller 20.

The chiller 20 may recollect the waste heat of the battery module 5 through heat-exchanging the coolant supplied from the battery module 5 through the second coolant line 4 with the refrigerant.

The refrigerant having passed through the chiller 20 may be introduced into the accumulator 15 along the connection line 21 and the opened refrigerant line 11. Thereafter, the refrigerant may pass through the accumulator 15 and be introduced into the compressor 10.

In other words, the refrigerant having passed through the accumulator 15, and the refrigerant supplied from the heat-exchanger 31 through the third line 35 may be introduced into the compressor 10. The introduced refrigerant may be compressed by the compressor 10.

The refrigerant compressed at the compressor 10 may pass through the condenser 12, and then may be supplied to the heat-exchanger 31 along the refrigerant line 11.

The heat pump system may repeatedly perform the above-described processes.

The ambient air introduced into the vehicle interior may be converted into a high-temperature state through heat-exchange with the high-temperature coolant introduced into the heating device 3 and introduced into the vehicle interior, thereby implementing heating of the vehicle interior.

Accordingly, the refrigerant circulated in the heat pump system may smoothly recollect the waste heat at the chiller 20 from the coolant having its temperature increased while passing through the battery module 5, thereby improving the overall heating performance and efficiency.

The present disclosure may improve the heating efficiency and performance while minimizing usage of a separate electric heater.

In other words, the heat pump system may increase the flow rate of the refrigerant flowing along the refrigerant line 11 while repeatedly performing the above-described operation.

The heat-exchanger 31 may heat-exchange the refrigerant expanded at the third expansion valve 33 after flowing from the condenser 12 to the first line 32 and the refrigerant condensed at the condenser 12 with each other, so that the condensation amount of the refrigerant may be decreased compared to the first heating mode described above.

As such, the gas injection device 30 may flow the refrigerant having its condensation amount decreased through the flow control of the refrigerant, so that the subcooling of the refrigerant discharged from the condenser 12 may be decreased compared to the first heating mode described above.

In other words, the second heating mode is operated when the heating load is small while the waste heat generated from the battery module 5 or an electrical component (not shown) is not sufficient, and by controlling the flow direction of the refrigerant discharged from the condenser 12 through the operation control of the gas injection device 30, the vehicle interior can be heated more efficiently when the heating load is small, compared to the first heating mode.

The gas injection device 30 may increase the flow rate of the refrigerant circulating through the refrigerant line 11, thereby maximizing the heating performance.

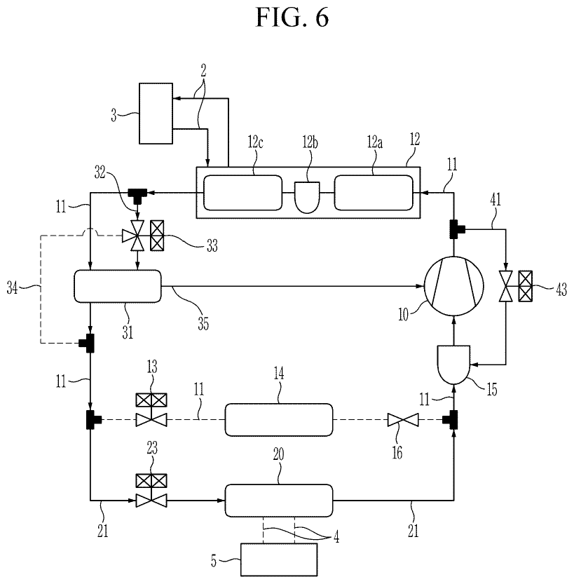

In an embodiment of the present disclosure, an operation of the first hot gas heating mode for heating the vehicle interior by using the refrigerant without recollecting heat, in which the gas injection device 30 is operated, is described in detail with reference to FIG. 6.

FIG. 6 is an operation diagram according to the first hot gas heating mode of a heat pump system for a vehicle according to an embodiment of the present disclosure.

Referring to FIG. 6, when the ambient air heat, the waste heat of the electrical component, and the waste heat of the battery module 5 are insufficient, the heat pump system may not recollect heat.

In other words, when heating of the vehicle interior is required while the external temperature is low and the heat generated by the electrical component and the battery module 5 is not sufficient in an early stage of driving the vehicle, the heat pump system may perform heating of the vehicle interior by directly using the high pressure and high-temperature refrigerant.

As such, heating of the vehicle interior by using only the refrigerant may be referred to as a hot gas heating mode.

In an embodiment of the present disclosure, in the first hot gas heating mode, a portion of the refrigerant line 11 connecting the compressor 10 and the condenser 12 may be opened.

A portion of the refrigerant line 11 connecting the condenser 12 to the first end of the connection line 21 and a portion of the refrigerant line 11 connected the second end of the connection line 21 to the compressor 10 may be opened.

A portion of the refrigerant line 11 connecting the evaporator 14 to the first end of the connection line 21, and a portion of the refrigerant line 11 connecting the second end of the connection line 21 to the evaporator 17 may be closed by the first expansion valve 13.

The connection line 21 may be opened by the second expansion valve 23.

The operation of the first expansion valve 13 may be stopped. Accordingly, the refrigerant is not supplied to the evaporator 14.

In addition, the control apparatus 16 may close the refrigerant line 11 connecting the evaporator 14 and the second end of the connection line 21, to prevent the refrigerant flowing along the connection line 21 from flowing backward to the evaporator 14.

In an embodiment of the present disclosure, the first line 32 may be opened by the third expansion valve 33. The second line 34 may be closed by the third expansion valve 33. In addition, the third line 35 may be opened.

The bypass line 41 may be opened by the fourth expansion valve 43.

In such a state, the refrigerant compressed at the compressor 10 may be introduced into the condenser 12 along the refrigerant line 11. The first coolant line 2 may be opened so that the coolant is supplied to the heating device 3.

Accordingly, the refrigerant introduced into the condenser 12 may be condensed while being heat-exchanged with the coolant supplied from the heating device 3 through the first coolant line 2. The coolant having its temperature increased through heat-exchange with the refrigerant at the condenser 12 may be supplied to the heating device 3.

The first condenser 12a may condense the refrigerant by using the coolant supplied from the heating device 3. The refrigerant having passed through the first condenser 12a may be introduced into the receiver dryer 12b along the refrigerant line 11.

The receiver dryer 12b may separate a gas component from the introduced refrigerant, and may only discharge the liquid refrigerant by filtering moisture and foreign substances. The refrigerant discharged from the receiver dryer 12b may be supplied to the second condenser 12c along the refrigerant line 11.

The second condenser 12c may additionally condense the refrigerant supplied from the receiver dryer 12b by heat-exchanging with the coolant supplied from the heating device 3.

A partial refrigerant among the refrigerant additionally condensed by the second condenser 12c may be introduced into the first line 32.

The third expansion valve 33 may expand the refrigerant introduced through the first line 32, and may supply the expanded refrigerant to the heat-exchanger 31 through the first line 32.

A remaining refrigerant among the refrigerant additionally condensed by the second condenser 12c may be introduced into the heat-exchanger 31 along the refrigerant line 11.

Accordingly, the heat-exchanger 31 may heat-exchange the refrigerant introduced through the first line 32 and the refrigerant supplied from the condenser 12 with each other. Thereafter, the heat-exchanger 31 may supply the gaseous refrigerant among the heat-exchanged refrigerant to the compressor 10 through the third line 35.

Through such an operation, the gas injection device 30 may flow the gaseous refrigerant discharged from the heat-exchanger 31 back to the compressor 10 through the third line 35, to increase the flow rate of the refrigerant circulating through the refrigerant line 11.

The refrigerant introduced into the heat-exchanger 31 from the condenser 12 may be additionally condensed through heat-exchange with the refrigerant supplied through the first line 32.

A remaining refrigerant among the refrigerant discharged from the heat-exchanger 31 may be introduced into the second expansion valve 23 along a portion of the refrigerant line 11 and the connection line 21.

The second expansion valve 23 may expand the refrigerant introduced through the connection line 21 and supply the expanded refrigerant to the chiller 20. The second coolant line 4 may be closed so that the refrigerant and the coolant are not heat-exchanged in the chiller 20.

In other words, since the heat generated at the battery module 5 is not sufficient, the coolant may not be introduced into the chiller 20.

The refrigerant having passed through the chiller 20 may be introduced into the accumulator 15 along the connection line 21 and the opened refrigerant line 11. Thereafter, the refrigerant may pass through the accumulator 15 and be introduced into the compressor 10.

In other words, the refrigerant having passed through the accumulator 15, and the refrigerant supplied from the heat-exchanger 31 through the third line 35 may be introduced into the compressor 10. The introduced refrigerant may be compressed by the compressor 10.

A partial refrigerant among the refrigerant compressed by the compressor 10 may be introduced into the fourth expansion valve 43 along the opened bypass line 41.

A remaining refrigerant among the refrigerant compressed by the compressor 10 may pass through the condenser 12, and then may be supplied to the heat-exchanger 31 along the refrigerant line 11.

The fourth expansion valve 43 may expand the refrigerant introduced through the bypass line 41. The refrigerant expanded at the fourth expansion valve 43 may be introduced into the accumulator 15 along the bypass line 41.

In other words, the refrigerant expanded by the second expansion valve 23 and having passed through the chiller 20 and the refrigerant expanded at the fourth expansion valve 43 may be introduced into the accumulator 15, respectively.

The refrigerant introduced into the accumulator 15 may be separated into gas liquid, and a gaseous refrigerant among the refrigerant separated into gas and liquid may be introduced into the compressor 10.

The refrigerant introduced into the compressor 10 may be supplied back to the condenser 12 and the fourth expansion valve 43, respectively.

The ambient air introduced into the vehicle interior may be converted into a high-temperature state through heat-exchange with the high-temperature coolant introduced into the heating device 3 and introduced into the vehicle interior, thereby implementing heating of the vehicle interior.

In other words, in an embodiment of the present disclosure, when the heat source is not sufficient in an early stage of driving the vehicle while the external temperature is low, the above-described operations are repeatedly performed, and the vehicle interior may be heated by using the high-temperature refrigerant supplied from the compressor 10.

In addition, the gas injection device 30 may increase the flow rate of the refrigerant circulating through the refrigerant line 11, thereby maximizing the heating performance.

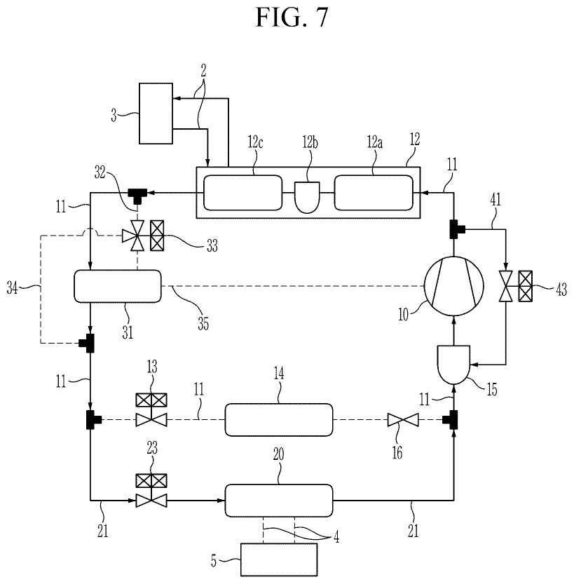

In addition, an operation of the second hot gas heating mode for heating the vehicle interior by using the refrigerant without recollecting heat, in which the gas injection device 30 is not operated, is described in detail with reference to FIG. 7.

FIG. 7 is an operation diagram according to the second hot gas heating mode of a heat pump system for a vehicle according to an embodiment of the present disclosure.

Referring to FIG. 7, when the ambient air heat, the waste heat of the electrical component, and the waste heat of the battery module 5 are insufficient, the heat pump system may not recollect heat.

In other words, when heating of the vehicle interior is required while the external temperature is low and the heat generated by the electrical component and the battery module 5 is not sufficient in an early stage of driving the vehicle, the heat pump system may perform heating of the vehicle interior by directly using the high pressure and high-temperature refrigerant.

As such, heating of the vehicle interior by using only the refrigerant may be referred to as a hot gas heating mode.

In an embodiment of the present disclosure, in the second hot gas heating mode, a portion of the refrigerant line 11 connecting the compressor 10 and the condenser 12 may be opened.

A portion of the refrigerant line 11 connecting the condenser 12 to the first end of the connection line 21 and a portion of the refrigerant line 11 connected the second end of the connection line 21 to the compressor 10 may be opened.

A portion of the refrigerant line 11 connecting the evaporator 14 to the first end of the connection line 21, and a portion of the refrigerant line 11 connecting the second end of the connection line 21 to the evaporator 17 may be closed by the first expansion valve 13.

The connection line 21 may be opened by the second expansion valve 23.

The operation of the first expansion valve 13 may be stopped. Accordingly, the refrigerant is not supplied to the evaporator 14.

The control apparatus 16 may close the refrigerant line 11 connecting the evaporator 14 and the second end of the connection line 21, to prevent the refrigerant flowing along the connection line 21 from flowing backward to the evaporator 14.

In an embodiment of the present disclosure, the first line 32 may be closed by the third expansion valve 33. The second line 34 may be closed by the third expansion valve 33. The third line 35 may be closed.

An operation of the third expansion valve 33 may be stopped.

The bypass line 41 may be opened by the fourth expansion valve 43.

In such a state, the refrigerant compressed at the compressor 10 may be introduced into the condenser 12 along the refrigerant line 11. The first coolant line 2 may be opened so that the coolant is supplied to the heating device 3.

Accordingly, the refrigerant introduced into the condenser 12 may be condensed while being heat-exchanged with the coolant supplied from the heating device 3 through the first coolant line 2. The coolant having its temperature increased through heat-exchange with the refrigerant at the condenser 12 may be supplied to the heating device 3.

The first condenser 12a may condense the refrigerant by using the coolant supplied from the heating device 3. The refrigerant having passed through the first condenser 12a may be introduced into the receiver dryer 12b along the refrigerant line 11.

The receiver dryer 12b may separate a gas component from the introduced refrigerant, and may only discharge the liquid refrigerant by filtering moisture and foreign substances. The refrigerant discharged from the receiver dryer 12b may be supplied to the second condenser 12c along the refrigerant line 11.

The second condenser 12c may additionally condense the refrigerant supplied from the receiver dryer 12b by heat-exchanging with the coolant supplied from the heating device 3.

The refrigerant additionally condensed at the second condenser 12c may pass through the heat-exchanger 31 along the refrigerant line 11.

A remaining refrigerant among the refrigerant discharged from the heat-exchanger 31 may be introduced into the second expansion valve 23 along a portion of the refrigerant line 11 and the connection line 21.

The second expansion valve 23 may expand the refrigerant introduced through the connection line 21 and supply the expanded refrigerant to the chiller 20. The second coolant line 4 may be closed so that the refrigerant and the coolant are not heat-exchanged in the chiller 20.

In other words, since the heat generated at the battery module 5 is not sufficient, the coolant may not be introduced into the chiller 20.

In addition, the refrigerant having passed through the chiller 20 may be introduced into the accumulator 15 along the connection line 21 and the opened refrigerant line 11. Thereafter, the refrigerant may pass through the accumulator 15 and be introduced into the compressor 10. The introduced refrigerant may be compressed by the compressor 10.

A partial refrigerant among the refrigerant compressed by the compressor 10 may be introduced into the fourth expansion valve 43 along the opened bypass line 41.

A remaining refrigerant among the refrigerant compressed by the compressor 10 may pass through the condenser 12, and then flow along the refrigerant line 11.

The fourth expansion valve 43 may expand the refrigerant introduced through the bypass line 41. The refrigerant expanded at the fourth expansion valve 43 may be introduced into the accumulator 15 along the bypass line 41.

In other words, the refrigerant expanded by the second expansion valve 23 and having passed through the chiller 20 and the refrigerant expanded at the fourth expansion valve 43 may be introduced into the accumulator 15, respectively.

The refrigerant introduced into the accumulator 15 may be separated into gas liquid, and a gaseous refrigerant among the refrigerant separated into gas and liquid may be introduced into the compressor 10.

The refrigerant introduced into the compressor 10 may be supplied back to the condenser 12 and the fourth expansion valve 43, respectively.

The ambient air introduced into the vehicle interior may be converted into a high-temperature state through heat-exchange with the high-temperature coolant introduced into the heating device 3 and introduced into the vehicle interior, thereby implementing heating of the vehicle interior.

In other words, in an embodiment of the present disclosure, when the heat source is not sufficient in an early stage of driving the vehicle while the external temperature is low, the above-described operations are repeatedly performed, and the vehicle interior may be heated by using the high-temperature refrigerant supplied from the compressor 10.

Therefore, as described above, according to a heat pump system for a vehicle according to an embodiment of the present disclosure, by using a single chiller 20 where the coolant and the refrigerant are heat-exchanged, the waste heat of the battery module 5 may be recollected, and the temperature of the battery module 5 may be adjusted depending on the air conditioning mode of the vehicle interior.

According to the present disclosure, by employing the gas injection device 30 selectively operating in the selected air conditioning mode of the vehicle interior, the flow rate of the refrigerant introduced into the HVAC module may be increased, thereby improving the cooling and heating performance.

The present disclosure may minimize the cooling and heating load and simultaneously improve the overall performance and efficiency of the system, by controlling the flow direction of the refrigerant introduced into the gas injection device 30 according to the cooling and heating load.

According to the present disclosure, the performance of the system by using the gas injection device 30 may be maximized while minimizing the required components, and accordingly, streamlining and simplification of the system may be achieved.

According to the present disclosure, by efficiently adjusting the temperature of the battery module 5, the optimal performance of the battery module 5 may be achieved, and the overall travel distance of the vehicle may be increased through efficient management of the battery module 5.

According to the present disclosure, through streamlining of an entire system, it is possible to reduce manufacturing cost and weight and improve space utilization.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2: first coolant line
3: heating device
4: second coolant line
5: battery module
10: compressor
11: refrigerant line
12: condenser
12a: first condenser
12b: receiver dryer
12c: second condenser
13: first expansion valve
14: evaporator
15: accumulator
16: control apparatus
20: chiller
21: connection line
23: second expansion valve
30: gas injection device
31: heat-exchanger
32: first line
33: third expansion valve
34: second line
35: third line
41: bypass line
43: fourth expansion valve

What is claimed is:

1. A heat pump system for a vehicle, the heat pump system comprising:
a compressor configured to compress a refrigerant;
a condenser connected to the compressor through a refrigerant line, and configured to condense the refrigerant;
a first expansion valve connected to the condenser through the refrigerant line;
an evaporator connected to the first expansion valve and the compressor through the refrigerant line, the evaporator configured to evaporate the refrigerant supplied from the refrigerant line;
a connection line including:
a first end connected to the refrigerant line between the condenser and the first expansion valve, and
a second end connected to the refrigerant line between the compressor and the evaporator;
a chiller provided on the connection line the chiller configured to exchange heat between the refrigerant introduced through the connection line and a coolant to adjust a temperature of the coolant;
a second expansion valve provided on the connection line at an upstream end of the chiller; and
a gas injection device provided on the refrigerant line between the condenser and the first expansion valve, the gas injection device configured to selectively expand the refrigerant supplied from the condenser and flow the refrigerant expanded by the gas injection device and selectively supply a partial refrigerant among the refrigerant supplied from the condenser to the compressor so as to increase a flow rate of the refrigerant circulating through the refrigerant line,
wherein a flow direction of the refrigerant is controlled through operation of the gas injection device based on at least one mode for controlling a temperature of a vehicle interior.

2. The heat pump system of claim 1, wherein the condenser comprises:
a first condenser connected to the compressor through the refrigerant line, the first condenser configured to condense the refrigerant via exchanging heat between the refrigerant supplied from the compressor and the coolant;
a receiver dryer connected to the first condenser through the refrigerant line; and
a second condenser connected to the receiver dryer through the refrigerant line, the second condenser configured to condense the refrigerant via exchanging heat between the refrigerant supplied from the receiver dryer and the coolant.

3. The heat pump system of claim 1, wherein the gas injection device comprises:
a heat-exchanger provided on the refrigerant line between the condenser and the first expansion valve;
a first line including:
a first end connected to the refrigerant line between the condenser and the heat-exchanger, and
a second end connected to the heat-exchanger;
a third expansion valve provided on the first line at an upstream end of the heat-exchanger;
a second line including:
a first end connected to the third expansion valve, and
a second end connected to the refrigerant line between the heat-exchanger and the first expansion valve; and
a third line including:
a first end connected to the heat-exchanger, and
a second end connected to the compressor.

4. The heat pump system of claim 3, wherein the heat-exchanger is configured to operate when the refrigerant expanded by the third expansion valve is supplied, and the heat exchanger is configured to supply a gaseous refrigerant, among the refrigerant supplied from the third expansion valve, to the compressor through the third line to increase a flow rate of the refrigerant circulating through the refrigerant line.

5. The heat pump system of claim 3, wherein, when the operation of the gas injection device is required, the third expansion valve is configured to expand the refrigerant supplied from the condenser through the first line or the refrigerant supplied from the heat-exchanger through the second line, and the third expansion valve is configured to supply the refrigerant expanded by the third expansion valve to the heat-exchanger.

6. The heat pump system of claim 3, wherein the at least one mode comprises:
a first cooling mode in which a battery module and the vehicle interior are cooled, by operating the gas injection device using the refrigerant discharged from the heat-exchanger;
a second cooling mode in which the battery module and the vehicle interior are cooled, by operating the gas injection device using the refrigerant discharged from the condenser;
a first heating mode in which the vehicle interior is heated, by operating the gas injection device using the refrigerant discharged from the heat-exchanger; and
a second heating mode in which the vehicle interior is heated, by operating the gas injection device using the refrigerant discharged from the condenser.

7. The heat pump system of claim 6, wherein, in the first cooling mode:
the refrigerant line interconnecting the compressor, the condenser, the first expansion valve, and the evaporator is configured to be opened;
the connection line is configured to be opened by the second expansion valve;
a portion of the first line connecting the first end of the first line to the third expansion valve is configured to be closed by the third expansion valve;
a remaining first line connecting the third expansion valve to the heat-exchanger is configured to be opened by the third expansion valve;
the second line is configured to be opened by the third expansion valve;
the third line is configured to be opened;
the first expansion valve is configured to expand the refrigerant introduced through the refrigerant line and supply the refrigerant expanded by the first expansion valve to the evaporator;
the second expansion valve is configured to expand the refrigerant introduced through the connection line and supply the refrigerant expanded by the second expansion valve to the chiller;
the third expansion valve is configured to expand the refrigerant introduced through the second line, and supply the refrigerant expanded by the third expansion valve to the heat-exchanger through the opened portion of the first line; and
the heat-exchanger is configured to supply a gaseous refrigerant among the refrigerant to the compressor through the opened third line.

8. The heat pump system of claim 6, wherein, in the second cooling mode:
the refrigerant line interconnecting the compressor, the condenser, the first expansion valve, and the evaporator is configured to be opened;
the connection line is configured to be opened by the second expansion valve;
the first line is configured to be opened by the third expansion valve;
the second line is configured to be closed by the third expansion valve;
the third line is configured to be opened;
the first expansion valve is configured to expand the refrigerant introduced through the refrigerant line and supply the refrigerant expanded by the first expansion valve to the evaporator;
the second expansion valve is configured to expand the refrigerant introduced through the connection line and supply the refrigerant expanded by the second expansion valve to the chiller;
the third expansion valve is configured to expand the refrigerant introduced through the first line, and supply the refrigerant expanded by the third expansion valve to the heat-exchanger through the first line; and
the heat-exchanger is configured to supply a gaseous refrigerant among the refrigerant to the compressor through the opened third line.

9. The heat pump system of claim 6, wherein, in the first heating mode:
a portion of the refrigerant line connecting the compressor and the condenser is configured to be opened;
a portion of the refrigerant line connecting the condenser to the first end of the connection line, and a portion of the refrigerant line connecting the second end of the connection line to the compressor are configured to be opened;
a portion of the refrigerant line connecting the evaporator to the first end of the connection line, and a portion of the refrigerant line connecting the second end of the connection line to the evaporator are configured to be closed by the first expansion valve;
the connection line is configured to be opened by the second expansion valve;
a portion of the first line connecting the first end of the first line to the third expansion valve is configured to be closed by the third expansion valve;
a remaining first line connecting the third expansion valve to the heat-exchanger is configured to be opened by the third expansion valve;
the second line is configured to be opened by the third expansion valve;
the third line is configured to be opened;
an operation of the first expansion valve is configured to be stopped;
the second expansion valve is configured to expand the refrigerant introduced through the connection line and supply the refrigerant expanded by the second expansion valve to the chiller;
the third expansion valve is configured to expand the refrigerant introduced through the second line, and supply the refrigerant expanded by the third expansion valve to the heat-exchanger through the opened portion of the first line; and
the heat-exchanger is configured to supply a gaseous refrigerant among the refrigerant to the compressor through the opened third line.

10. The heat pump system of claim 6, wherein, in the second heating mode:
a portion of the refrigerant line connecting the compressor and the condenser is configured to be opened;
a portion of the refrigerant line connecting the condenser to the first end of the connection line, and a portion of the refrigerant line connecting the second end of the connection line to the compressor are configured to be opened;
a portion of the refrigerant line connecting the evaporator to the first end of the connection line, and a portion of the refrigerant line connecting the second end of the connection line to the evaporator are configured to be closed by the first expansion valve;
the connection line is configured to be opened by the second expansion valve;
the first line is configured to be opened by the third expansion valve;
the second line is configured to be closed by the third expansion valve;
the third line is configured to be opened;
an operation of the first expansion valve is configured to be stopped;
the second expansion valve is configured to expand the refrigerant introduced through the connection line and supply the refrigerant expanded by the second expansion valve to the chiller;
the third expansion valve is configured to expand the refrigerant introduced through the first line, and supply the refrigerant expanded by the third expansion valve to the heat-exchanger through the first line; and
the heat-exchanger is configured to supply a gaseous refrigerant among the refrigerant to the compressor through the opened third line.

11. The heat pump system of claim 3, further comprising:
an accumulator provided on the refrigerant line between the evaporator and the compressor;
a bypass line including:
a first end connected to the refrigerant line between the compressor and the condenser, and
a second end connected to the accumulator; and
a fourth expansion valve provided on the bypass line.

12. The heat pump system of claim 11, wherein the fourth expansion valve is configured to open the bypass line during hot gas heating for heating the vehicle interior using the refrigerant without recollecting heat, and the fourth expansion valve is configured to expand the refrigerant introduced into the bypass line from the compressor and supply the refrigerant expanded by the fourth expansion valve to the accumulator.

13. The heat pump system of claim 11, wherein the at least one mode further comprises:
a first hot gas heating mode in which the vehicle interior is heated using the refrigerant without recollecting heat, by operating the gas injection device; and
a second hot gas heating mode in which the vehicle interior is heated using the refrigerant without recollecting heat, without operating the gas injection device.

14. The heat pump system of claim 13, wherein, in the first hot gas heating mode:
a portion of the refrigerant line connecting the compressor and the condenser is configured to be opened;
a portion of the refrigerant line connecting the condenser to the first end of the connection line, and a portion of the refrigerant line connecting the second end of the connection line to the compressor are configured to be opened;
a portion of the refrigerant line connecting the evaporator to the first end of the connection line, and a portion of the refrigerant line connecting the second end of the connection line to the evaporator are configured to be closed by the first expansion valve;
the connection line is configured to be opened by the second expansion valve;
the first line is configured to be opened by the third expansion valve;
the second line is configured to be closed by the third expansion valve;
the third line is configured to be opened;
the bypass line is configured to be opened by the fourth expansion valve;
an operation of the first expansion valve is configured to be stopped;
the second expansion valve is configured to expand the refrigerant introduced through the connection line and supply the refrigerant expanded by the second expansion valve to the chiller;
the third expansion valve is configured to expand the refrigerant introduced through the first line, and supply the refrigerant expanded by the third expansion valve to the heat-exchanger through the first line;
the fourth expansion valve is configured to expand the refrigerant introduced through the bypass line, and supply the refrigerant expanded by the fourth expansion valve to the accumulator through the bypass line; and
the heat-exchanger is configured to supply a gaseous refrigerant among the refrigerant to the compressor through the opened third line.

15. The heat pump system of claim 13, wherein, in the second hot gas heating mode:
a portion of the refrigerant line connecting the compressor and the condenser is configured to be opened;
a portion of the refrigerant line connecting the condenser to the first end of the connection line, and a portion of the refrigerant line connecting the second end of the connection line to the compressor are configured to be opened;
a portion of the refrigerant line connecting the evaporator to the first end of the connection line, and a portion of the refrigerant line connecting the second end of the connection line to the evaporator are configured to be closed by the first expansion valve;
the connection line is configured to be opened by the second expansion valve;
the first line is configured to be closed by the third expansion valve;
the second line is configured to be closed by the third expansion valve;
the third line is configured to be closed;
the bypass line is configured to be opened by the fourth expansion valve;
an operation of the first expansion valve and the third expansion valve is configured to be stopped;
the second expansion valve is configured to expand the refrigerant introduced through the connection line and supply the refrigerant expanded by the second expansion valve to the chiller; and
the fourth expansion valve is configured to expand the refrigerant introduced through the bypass line, and supply the refrigerant expanded by the fourth expansion valve to the accumulator through the bypass line.

16. The heat pump system of claim 6, wherein:
the first expansion valve and the second expansion valve are 2-way electronic expansion valves configured to selectively expand the refrigerant while controlling the flow direction of the supplied refrigerant; and
the third expansion valve is a 3-way electronic expansion valve configured to selectively expand the refrigerant while controlling the flow direction of the refrigerant.

17. The heat pump system of claim 1, wherein a control apparatus is provided on the refrigerant line between the evaporator and the compressor, the control apparatus configured to adjust a pressure of the refrigerant line and prevent the refrigerant from flowing backward in the refrigerant line.

18. The heat pump system of claim 1, further comprising a battery module through which the coolant circulates, and a heating device through which the coolant circulates to heat the vehicle interior using a high-temperature coolant,
wherein the condenser is connected to the heating device through a first coolant line through which the coolant circulates, and
wherein the chiller is connected to the battery module through a second coolant line through which the coolant circulates.

19. The heat pump system of claim 18, wherein the first coolant line is configured to be opened to connect the condenser and the heating device when heating the vehicle interior.

20. The heat pump system of claim 18, wherein, when the battery module is to be cooled while cooling the vehicle interior, or when a waste heat of the battery module is to be recollected while heating the vehicle interior, the second coolant line is configured to be opened to connect the chiller and the battery module.
